(19) United States
(12) Patent Application Publication
(10) Pub. No.: US 2024/0391430 A1
(43) Pub. Date: Nov. 28, 2024

(54) TRAILER LANDING GEAR ADAPTER

(71) Applicant: Jon Richardson, Bloomingtion, IN (US)

(72) Inventor: Jon Richardson, Bloomingtion, IN (US)

(21) Appl. No.: 17/590,053

(22) Filed: Feb. 1, 2022

Related U.S. Application Data
(60) Provisional application No. 63/144,745, filed on Feb. 2, 2021.

(51) Int. Cl. B60S 9/08; B60D 1/66

(52) U.S. Cl. CPC B60S 9/08; B60D 1/66

(57) ABSTRACT

An adapter for a trailer landing gear assembly. The adapter has a tool coupling section sized to be received in a chuck of a drill, an input shaft receiver configured to be selectively positioned around an input shaft of the landing gear assembly, and a locking pin selectively positionable through a portion of the input shaft receiver.

### CROSS-REFERENCE TO RELATED APPLICATION

The present disclosure claims the benefit of U.S. Provisional Application No. 63/144,745, filed Feb. 2, 2021, the contents of which are hereby incorporated herein in entirety.

### FIELD OF THE DISCLOSURE

The present disclosure relates to an adapter for altering landing gear for a trailer, and more specifically to an adapter that can be coupled to an electric hand tool.

### BACKGROUND

Automotive trailers and the like frequently have a landing gear assembly thereon that allows the trailer to be raised and uncoupled from a towing vehicle. One common configuration is a tractor/trailer used for long-haul trucking frequently referred to as a semi. Often, the landing gear assembly has a telescoping base member that moves linearly perpendicular to the underlying ground. The linear position of the base member can often be adjusted by manually cranking a hand lever to raise or lower the base member. In one example, the manual hand lever may be cranked in one direction to extend the landing gear assembly until a hitch assembly of the trailer is positioned at a height that allows a corresponding hitch assembly of the towing vehicle to be positioned thereunder. After the corresponding hitch assemblies are aligned, the manual hand lever may be rotated by a user to retract the landing gear assembly until the hitch assemblies are coupled to one another and the base of the landing gear assembly is sufficiently spaced from the underlying surface. Similarly, the hitch assemblies may be uncoupled from one another by extending the landing gear assembly to raise the trailer hitch off the corresponding towing vehicle hitch. The landing gear assembly may then maintain the position of the trailer as the towing vehicle moves to a different location uncoupled from the trailer.

The conventional landing gear assembly requires a user to manually crank the hand lever to retract and extend the base. This can be a tedious and tiresome process depending on the load on the trailer and the distance that the base must move. Regardless, manually cranking the landing gear assembly can be physically difficult for the user.

### SUMMARY

One embodiment is an adapter for a trailer landing gear assembly. The trailer assembly comprises a tool coupling section sized to be received in a tool, an input shaft receiver configured to be selectively positioned around an input shaft of the landing gear assembly, and a securing mechanism selectively positionable through a portion of the input shaft receiver. The securing mechanism in this embodiment is a locking pin with a retention member, and the locking pin has a pull ring. In this embodiment, the outer surface of the input shaft receiver has at least a partially cylindrical shape, and the tool coupling section has a hexagonal shaped cross section that has a size of about 7/16 of an inch. In this embodiment, the input shaft receiver has a cylindrical cavity, and the cylindrical cavity has a diameter of about one and nine-hundredths of an inch. In this embodiment, the input shaft receiver has pin through-holes wherein the pin through-holes have a diameter of about three-eighths of an inch. In this embodiment the input shaft receiver has a back wall and the cylindrical cavity extends about two and one-half inches beyond the back wall. The tool in this embodiment is a drill.

In another embodiment, an adapter for a trailer landing gear assembly includes a tool coupling section configured to be coupled to a drill, an input shaft receiver having a cylindrical outer surface and configured to be selectively positioned around an input shaft of the landing gear assembly, and a locking pin selectively positionable through a portion of the input shaft receiver.

In another embodiment, an adapter for a trailer landing gear assembly includes a tool coupling section configured to be coupled to a tool, an input shaft receiver that defines a cylindrical cavity sized to receive an input shaft of the landing gear assembly, and a locking pin selectively positionable through a portion of the input shaft receiver. In this embodiment the cylindrical cavity has a diameter of about one and nine-hundredths of an inch. Further, in this embodiment the locking pin is inserted through pin through holes and the pin through-holes have a diameter of about three-eighths of an inch.

In another embodiment, a method for raising and lowering landing gear includes coupling a landing gear shaft receiver to an input shaft of a landing gear, coupling a tool coupling section to a power tool, raising and lowering landing gear by operating a power tool, where operating the power tool in a first rotational direction raises the landing gear, and operating the power tool in a second rotational direction lowers the landing gear. In this embodiment the input shaft receiver has pin through-holes, and the pin through-holes have a diameter of about three-eighths of an inch. In addition, this embodiment has a locking pin that is inserted through the pin through-holes.

Another embodiment is a method for raising and lowering landing gear, the method comprising coupling a tool coupling section to a power tool, coupling a landing gear shaft receiver to an input shaft of a landing gear, and raising and lowering the landing gear by operating the power tool. In this embodiment, operating the power tool in a first rotational direction raises the landing gear, and operating the power tool in a second rotational direction lowers the landing gear. Additionally, in this embodiment the landing gear shaft receiver is coupled to the input shaft of a landing gear with a locking pin, and the locking pin has a retention member that is springedly coupled to the locking pin and retracts into the locking pin when sufficient pressure is applied thereto. In this embodiment the input shaft receiver has a cylindrical cavity, and this cavity has a diameter of about one and nine-hundredths of an inch. In this embodiment the input shaft receiver has pin through-holes, and the pin through-holes have a diameter of about three-eighths of an inch.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is an elevated perspective view of a landing gear adapter;

FIG. 2 is a bottom perspective view of the landing gear adapter of FIG. 1;

FIG. 3 is a section side view of the landing gear adapter of FIG. 1; and

FIG. 4 is a schematic section view of the landing gear adapter of FIG. 1 coupled to a tool and landing gear assembly.

Corresponding reference numerals are used to indicate corresponding parts throughout the several views.

### DETAILED DESCRIPTION

For the purposes of promoting an understanding of the principles of the present disclosure, reference will now be made to the embodiments described herein and illustrated in the drawings and specific language will be used to describe the same. It will nevertheless be understood that no limitation of the scope of the present disclosure is thereby intended, such alterations and further modifications in the illustrated devices and methods, and such further applications of the principles of the present disclosure as illustrated therein being contemplated as would normally occur to one skilled in the art to which the present disclosure relates.

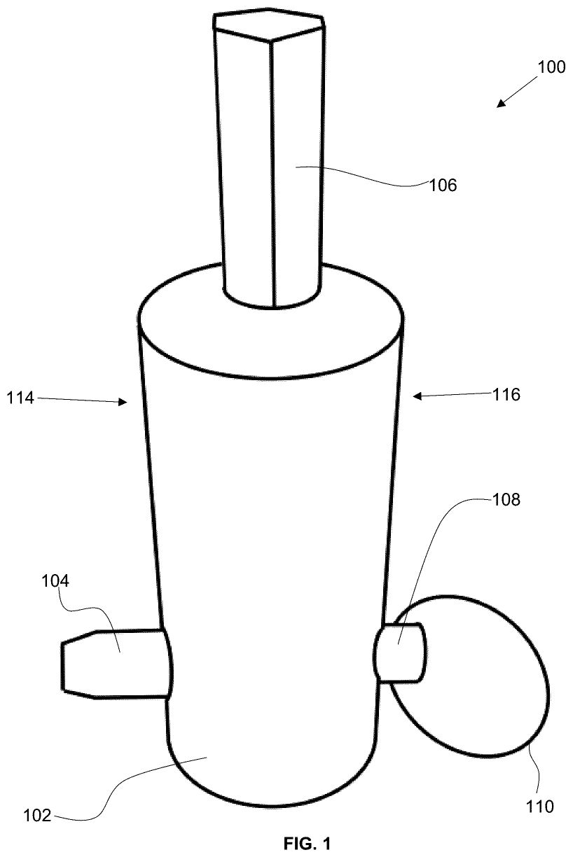

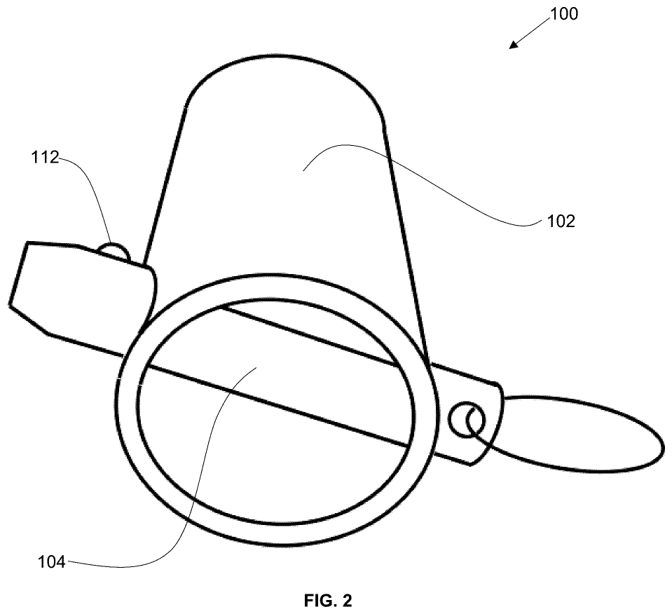

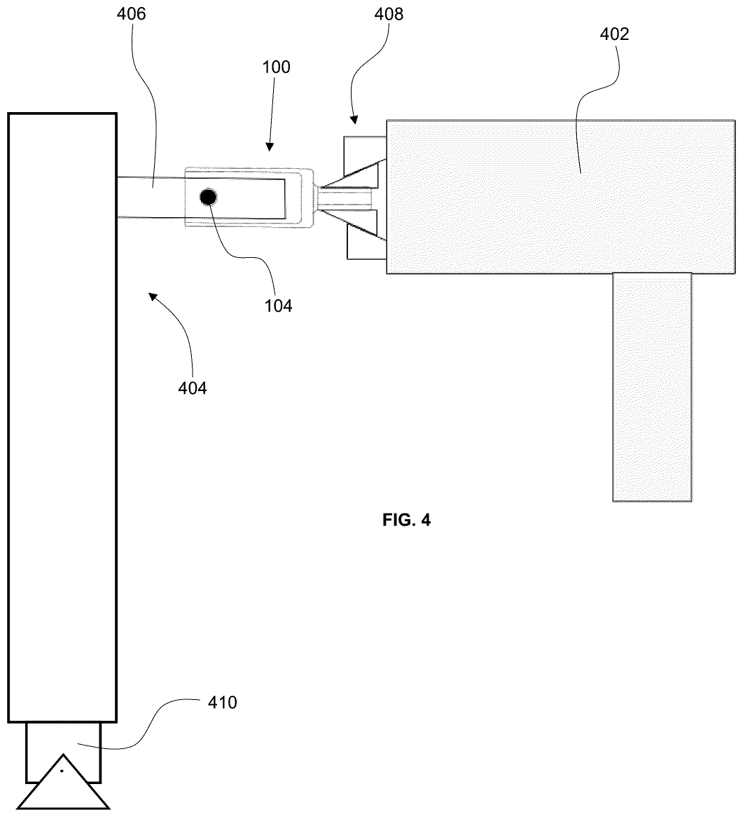

The present disclosure relates to a landing gear adapter 100 that is configured to be coupled to a landing gear assembly 404 (see FIG. 4) of a trailer. The landing gear assembly 404 referred to herein may be any assembly that is selectively extendable to alter or maintain the position of a trailer. For a non-exclusive example of a landing gear assembly, see U.S. Pat. No. 7,240,921, the contents of which are hereby incorporated herein by reference. Referring to FIGS. 1 and 2, the landing gear adapter 100 has an input shaft receiver 102 that can be selectively coupled to an input shaft 406 of the landing gear assembly 404. Further, the input shaft receiver 102 has a locking pin 104 that can be selectively positioned through the input shaft receiver 102 to selectively lock the input shaft receiver 102 to the input shaft.

The landing gear adapter 100 also has a tool coupling section 106 that may be selectively coupled to a remote tool such as a drill. In one example, the tool coupling section 106 may have a 7/16-inch hex-shaped cross section sized to be received by a chuck of a drill. In another embodiment, the tool coupling section 106 may have a hex-shaped cross section of less than two inches. In another embodiment, the tool coupling section 106 may have a hex-shaped cross section of less than one inch. In still another embodiment, the tool coupling section 106 may have less than a ½-inch hex-shaped cross section. In another embodiment, the tool coupling section 106 may have less than a ¼-inch hex-shaped cross section. In another embodiment, the tool coupling section 106 may be a straight shank. In another embodiment, the tool coupling section 106 may be a triangle shank. In yet another embodiment, the tool coupling section 106 may be a morse taper shank. In another embodiment, the tool coupling section 106 may be a square shank. In another embodiment, the tool coupling section 106 may be a threaded shank. In still another embodiment, the tool coupling section 106 may be a slotted drive shaft (SDS) shank. While certain shapes, sizes, and coupling methods of the tool coupling section are disclosed above, this disclosure also contemplates other sizes and shapes for the tool coupling section 106, and other methods of coupling the tool coupling section 106 to the remote tool.

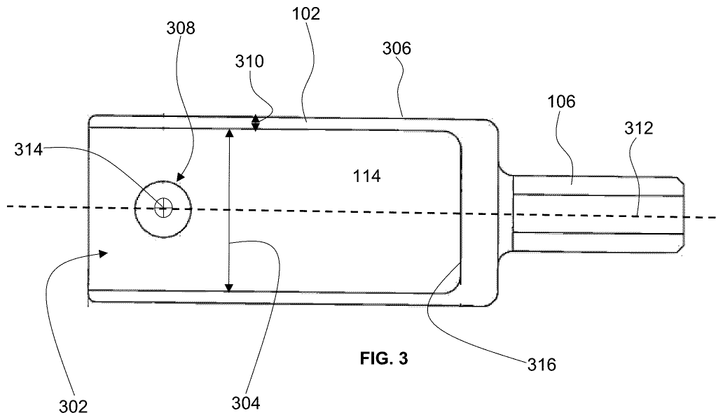

Referring now to FIG. 3, in one aspect of this disclosure the input shaft receiver 102 may have a substantially cylindrical cavity 302 defined therein. The cylindrical cavity 302 may have a diameter sized to be slightly greater than the outside diameter of the typical input shaft 406 of the landing gear assembly 404. In this configuration, the input shaft receiver 102 may be positioned at least partially over the input shaft 406 by positioning the input shaft 406 at least partially within the cylindrical cavity 302. In one example of this disclosure, the input shaft 406 may have a diameter about one inch and the cylindrical cavity 302 may have a diameter 304 of about one and nine-hundredths of an inch. In another embodiment, the cylindrical cavity 302 may have a diameter between about one and nine hundredths of an inch and ½ an inch. In another embodiment, the cylindrical cavity 302 may have a diameter of between about one and nine-hundredths of an inch and two inches. However, this disclosure considers implementing the teachings discussed herein with any sized input shaft and the diameter of the cylindrical cavity 302 may be sized to be slightly greater than any size input shaft so the input shaft can be positioned at least partially within the cylindrical cavity 302.

The input shaft receiver 102 may have a corresponding cylindrical outer surface 306. In this configuration, the inner wall of the cylindrical cavity may be separated from the outer surface 306 by a wall thickness 310. The wall thickness 310 may by sufficiently thick to ensure the landing gear adapter 100 can accommodate expected torsional loads while raising or lowering the landing gear assembly 404. However, the wall thickness 310 may be sufficiently thin such that the landing gear adapter 100 is light and easily portable. Further, the cylindrical outer surface 306 may allow the landing gear adapter 100 to be positioned around input shafts with minimal radial spacing. The cylindrical outer surface 306 may also not easily be snagged on material that may come into contact therewith during use. Accordingly, the cylindrical outer surface 306 provides both functional and safety advantages among others.

The input shaft receiver 102 may have pin through-holes 308 defined there-through. The pin through-holes 308 may have a diameter that is slightly larger than the locking pin 104 to thereby allow the locking pin 104 to be selectively inserted into, and removed from, the input shaft receiver 102. The pin through-holes 308 may extend through one side of the input shaft receiver 102, through a rotation axis 312 of the landing gear adapter 100, and out the other side of the input shaft receiver 102. The pin through-holes 308 may be defined along a pin axis 314 that is perpendicular to, and intersects with, the rotation axis 312.

In one embodiment, there are two pin through-holes 308 in the input shaft receiver 102. In this embodiment, a first pin through-hole 308 may be on a first side 114 of the input shaft receiver 102 and a second pin through-hole 308 may be on a second side 116. In another embodiment, there may only be one pin through-hole 308. In another embodiment, there may be three pin through-holes 308. In still another embodiment, there may be four pin through-holes 308. In one embodiment one or more pin through-holes 308 may be located on the first side 114 and one or more pin through-holes may be located on the second side 116 of the input shaft receiver 102. In another embodiment, one or more pin through-holes 308 may be on the first side 114 of the input shaft receiver 102, one or more pin through-holes 308 may be on the second side 116 of the input shaft receiver 102, and one or more pin through-holes 308 may be at a axial position between the first and second pin through-holes 308 and located closer to the tool back wall 316 than the pin through-holes on the first and second side 114, 116 of the input shaft receiver 102. In another embodiment, one or more pin through-holes 308 may be on the first side 114 of the input shaft receiver 102, one or more pin through-holes 308 may be on the second side 116 of the input shaft receiver 102, and one or more pin through-holes 308 may be at a radial position between the first and second pin through-holes 308 and located farther from the back wall 316 than the pin through-holes on the first and second side 114, 116 of the input shaft receiver 102. Further, the pin axis 314 of the pin through-holes 308 may be spaced about two inches from the back wall 316. However, other dimensions are considered herein as well, and the specific dimensions may be modified to match those of a corresponding input shaft 406.

In one example of this disclosure, the pin through-holes 308 may have a diameter of about three-eighths of an inch. This diameter may correspond with a slightly smaller diameter of the locking pin 104. Further, the locking pin 104 may have an expanded head 108 that has a radius slightly greater than the radius of the pin through-holes 308. In this configuration, the locking pin 104 may be positioned through the pin through-holes 308 on both sides of the input shaft receiver 102 until the expanded head 108 prevents further movement through the pin through-holes 308. The locking pin 104 may be sized such that when the expanded head 108 contacts the input shaft receiver 102, the locking pin 104 is fully positioned through the pin through-holes 308. Further, a pull ring 110 may be pivotally coupled to the expanded head 108 to allow a user to selectively pull the locking pin 104 from the input shaft receiver 102. In another embodiment, the locking pin 104 may have a handle coupled to the expanded head 108 to allow the user to selectively pull the locking pin 104 from the input shaft receiver 102.

In yet another aspect of this disclosure, a retention member 112 may be positioned in a portion of the locking pin 104 spaced from the expanded head 108. The retention member 112 may be springedly coupled to the pin 104 to retract into the pin 104 when sufficient pressure is applied thereto. In this configuration, the pin 104 may be forced through the pin through-holes 308 and the retention member 112 will deflect inwardly when a sufficient force is applied. However, once the pin 104 is fully positioned through the through-holes 308 as illustrated in FIG. 1 (i.e., when the expanded head 108 is proximate to the outer surface 306), the retention member 112 may extend away from the outer surface of the pin 104 to thereby prevent the pin from unintentionally sliding out of the input shaft receiver 102.

While a locking pin 104 with an expanded head 108 and a retention member 112 is disclosed, any other securing mechanisms known in the art may be used to secure the input shaft 406 of the landing gear assembly 404 to the input shaft receiver 102. In one embodiment the securing mechanism may be a latch lock, where one or more latches extends through one or more pin through-holes 308 and rotate into a locked position. In another embodiment the one or more securing mechanisms may be one or more hair pins, which are slidably inserted in the pin through-holes 308. In another embodiment the input shaft receiver 102 may be secured to the input shaft 406 of the landing gear assembly 404 with one or more pins that are at least partially threaded, and after the pins are inserted through the pin through-holes 308 the one or more pins are secured with one or more fasteners, such as a nut.

The cylindrical cavity 302 may extend about two and one-half inches from a back wall 316. In another embodiment the cylindrical cavity 302 may extend less than about four inches from the back wall. In another embodiment, the cylindrical cavity 302 may extend less than about three inches from the back wall 316. In still another embodiment the cylindrical cavity 302 may extend less than about two inches from the back wall 316. In another embodiment the cylindrical cavity 302 may extend less than about one inch form the back wall 316.

In use, the tool coupling section 106 may be coupled to a tool such as a wireless drill. The chuck on the wireless drill may be expanded to receive the tool coupling section 106 and then tightened there-around to hold the landing gear adapter 100 in the chuck of the drill. The locking pin 104 may be removed from the input shaft receiver 102 and the input shaft receiver 102 may be positioned around an input shaft 406 of a trailer landing gear assembly 404. The landing gear adapter 100 may be moved axially and rotated while the input shaft 406 is positioned within the cylindrical cavity 302 until a through-hole in the input shaft 406 is aligned with the pin through-holes 308. The locking pin 104 may then be positioned through the input shaft receiver 102 and the corresponding input shaft through-hole until the retention member 112 sufficiently clears the outer surface 306 of the input shaft receiver 102. At this point, the user may activate the drill to rotate the input shaft with the landing gear adapter 100. The torque produced by the drill may be distributed through the tool coupling section 106, the back wall 316, the input shaft receiver 102, and into the input shaft 406 through the locking pin 104. In another embodiment, the tool coupling section 106 may be coupled to a corded drill. In still another embodiment the tool coupling section 106 may be coupled to an impact driver.

While certain steps for using the landing gear adapter 100 are discussed sequentially, the landing gear adapter 100 may be used utilizing different implementation orders as well. For example, the input shaft receiver 102 may be coupled to the input shaft with the locking pin 104 before the drill is coupled to the tool coupling section 106.

One aspect of this disclosure includes a method for manufacturing the landing gear adapter 100. The method includes forming the tool coupling section 106 sized to be received in a tool. This may be done by providing a piece of raw material such as aluminium or steel and milling the raw material to form the tool coupling section 106. Alternatively, this could be done through a known moulding process wherein the tool coupling section 106 is formed as part of a mould. Similarly, the input shaft receiver 108 may be formed extending from the tool coupling section 106 and sized to be selectively positioned at least partially around an input shaft 406 of the landing gear assembly 404. The input shaft receiver 108 may also be formed from a milling or moulding process. In one example, both the tool coupling section 106 and the input shaft receiver are formed from the same material (i.e., milled from the same blank or moulded as part of the same mould). Alternatively, the coupling section 106 and the input shaft receiver 108 may be formed as separate components and coupled to one another through a welding or the like process.

After the input shaft receiver 108 is formed, the pin through-holes 308 may be formed through the input shaft receiver 108. The pin through-holes 308 may be formed by a drilling process wherein a drill bit removes material from the input shaft receiver 108 to form the pin through-holes 308. While specific manufacturing methods are discussed herein, this disclosure contemplates using any known manufacturing technique to form the landing gear adapter 100 discussed herein.

Referring now to FIG. 4, a cross-section exemplary view of the landing gear adapter 100 coupled to a tool 402 and the input shaft 406 of a trailer landing gear assembly 404 is illustrated. The tool 402 may be a corded or cordless hand drill that has a chuck 408 or other coupling device that allows the tool 402 to be selectively coupled to the tool coupling section 106 of the landing gear adapter 100. Further, the landing tool adapter 100 is coupled to the input shaft 406 by positioning the input shaft 406 within the cylindrical cavity 302 of the landing gear adapter 100. The locking pin 104 may travel through the pin through-holes 308 of the landing gear adapter 100 and through a corresponding through-hole of the input shaft 406. In this configuration, the landing gear adapter 100 is rotationally coupled to the input shaft 406. Accordingly, as the tool 402 provide a rotating force to the landing gear adapter 100, the input shaft 406 is rotated therewith to raise or lower an extension portion 410 of the landing gear assembly 404.

FIG. 4 is a schematic representation of a landing gear assembly 404. While only one landing gear assembly 404 and extension portion 410 are illustrated, often two landing gear assemblies and corresponding extension portions are connected to one another. In this configuration, the input shaft 406 may drive both landing gear assemblies and extension arms. That is to say, the single input shaft 406 may control two landing gear assemblies to raise and lower the landing gear assemblies.

While an exemplary embodiment incorporating the principles of the present application has been disclosed hereinabove, the present application is not limited to the disclosed embodiments. Instead, this application is intended to cover any variations, uses, or adaptations of the application using its general principles. Further, this application is intended to cover such departures from the present disclosure as come within known or customary practice in the art to which this present application pertains and which fall within the limits of the appended claims.

1. An adapter for a trailer landing gear assembly, comprising:
a tool coupling section sized to be received in a tool;
an input shaft receiver configured to be selectively positioned around an input shaft of the landing gear assembly, the input shaft receiver defining three pin through-holes; and
a securing mechanism selectively positionable through a portion of the input shaft receiver.

2. The adapter of claim 1, wherein the securing mechanism is a locking pin with a retention member.

3. The adapter of claim 2, wherein the locking pin has a pull ring.

4. The adapter of claim 1, wherein the outer surface of the input shaft receiver has at least a partially cylindrical shape.

5. The adapter of claim 1, wherein the tool coupling section has a hexagonal shaped cross section.

6. The adapter of claim 5, wherein the hexagonal shaped cross section has a size of about 7/16 of an inch.

7. The adapter of claim 1, wherein the input shaft receiver has a cylindrical cavity.

8. The adapter of claim 7, wherein the cylindrical cavity has a diameter of greater than one inch and is configured to allow an input shaft to be at least partially positioned therein.

9. (canceled)

10. The adapter of claim 7, wherein the input shaft receiver has a back wall;
further wherein the cylindrical cavity extends about two and one-half inches beyond the back wall.

11. The adapter of claim 1, wherein the tool coupling section is sized to be received by the chuck of a cordless drill.

12. An adapter for a trailer landing gear assembly, consisting of:
a tool coupling section configured to be coupled to a drill;
an input shaft receiver having a cylindrical outer surface and configured to be selectively positioned around an input shaft of the landing gear assembly, the input shaft receiver defining three pin through-holes; and
a locking pin selectively positionable through a portion of the input shaft receiver
wherein the tool coupling section and the input shaft receiver are formed through milling a single piece of a raw material.

13. The assembly of claim 12, wherein the input shaft receiver has a cylindrical cavity with a diameter of about one and nine-hundredths of an inch.

14. The assembly of claim 12, wherein the locking pin is inserted through at least one of the three pin through-holes defined through the input shaft receiver.

15. A method for manufacturing an adapter for a trailer landing gear assembly, consisting of:
providing a raw material:
milling a tool coupling section into the raw material, the tool coupling section sized to be received in a tool:
milling an input shaft receiver into the raw material, the input shaft receiver extending from the tool coupling section and sized to be selectively positioned at least partially around an input shaft of the landing gear assembly; and
forming three pin through-holes through the input shaft receiver, each of the three pin through-holes sized to selectively receive a securing mechanism.

16. The method of claim 15, wherein the input shaft receiver is formed so an outer surface of the input shaft receiver has at least a partially cylindrical shape.

17. The method of claim 15, wherein the tool coupling section is formed to have a hexagonal shaped cross section.

18. The method of claim 15, wherein the input shaft receiver is formed to have a cylindrical cavity.

19. The method of claim 18, wherein the cylindrical cavity has a diameter of greater than one inch and is configured to allow an input shaft to be at least partially positioned therein.

20. The method of claim 15, wherein the tool coupling section is sized to be received by the chuck of a cordless drill.
